(19) United States
(12) Patent Application Publication
(10) Pub. No.: US 2018/0058553 A1
(43) Pub. Date: Mar. 1, 2018

(54) THREADED DRIVE SHAFT

(71) Applicant: SCHAEFFLER TECHNOLOGIES AG & CO. KG, Herzogenaurach (DE)

(72) Inventors: Reinhard KICK-RODENBUECHER, Nuernberg (DE); Mario KREUTZER, Herzogenaurach (DE)

(73) Assignee: SCHAEFFLER TECHNOLOGIES AG & CO. KG, Herzogenaurach (DE)

(21) Appl. No.: 15/693,793

(22) Filed: Sep. 1, 2017

(30) Foreign Application Priority Data
Sep. 1, 2016 (DE) 102016216496.1

(51) Int. Cl. F16H 25/20; F16H 25/22

(52) U.S. Cl. CPC F16H 25/2015; F16H 25/2233

(57) ABSTRACT

A threaded drive shaft is provided that has a threaded spindle, a spindle nut, and a spindle disk. The threaded spindle has two different sections with two different outer diameters. The spindle nut is about the larger-diameter portion, such that rotation of the threaded spindle within the spindle nut is allowed. The spindle disk is connected about the smaller-diameter portion of the threaded spindle, and is fixed thereto in a rotationally-fixed manner. The spindle disk has a tapered surface contacting a corresponding tapered surface of the threaded spindle to inhibit rotation. The spindle disk further includes a flange extending from an outer surface thereof that defines a first limit stop surface configured to contact a second limit stop surface of the spindle nut to limit rotation.

### CROSS-REFERENCE TO RELATED APPLICATIONS

This application claims priority to DE 102016216496.1, filed Sep. 1, 2016, the entire disclosures of which are incorporated by reference herein.

### TECHNICAL FIELD

This disclosure relates generally to a threaded drive shaft, and in particular to a ball screw drive shaft, which features an effective limit stop between a threaded spindle and a spindle nut.

### BACKGROUND

Such a threaded drive shaft is known from e.g. DE 10 2009 036 824 A1. A threaded nut, in other words a spindle nut of this threaded drive shaft can be produced by means of forming procedures and features an integrated limit stop surface. The limit stop surface works in circumferential direction and prevents a tensioning of components of the threaded drive shaft in axial direction.

Various construction versions of ball screw drive shafts are known from DE 10 2008 025 348 A1 and from DE 10 2008 025 349 A1, in which limit stop elements, which limit a turning of a spindle nut in relation to a threaded spindle, are integrated in a respective diverter piece of the spindle nut that is intended for the feeding back of the roller element.

DE 10 2014 219 256 B4 discloses a ball screw drive shaft with a sleeve that is surrounding a spindle nut, which was produced by means of a forming procedure, onto which a circumferential limit stop, which is interacting with a threaded spindle is formed, as well as a locking device, which protects the spindle nut against turning.

A ball screw drive shaft is known from EP 2 464 894 B1, which features an effective limit stop between a threaded spindle and a threaded nut, whereby a stop element is arranged at the threaded spindle. In order to determine a rotary position of the limit stop element, this element, as well as the threaded nut, is provided with a marking.

DE 10 2009 036 884 A1 discloses a ball screw drive shaft with a threaded spindle that is supported on an axial bearing. A support disk of this known ball screw drive shaft is arranged on a threaded spindle in a way that it can wobble. At the same time, it is possible to transfer torque between the support disk and the threaded spindle.

One objective of this disclosure is to present a threaded drive shaft, e.g. a ball screw drive shaft, having a limit stop that can be produced in a rational way, that can particularly be integrated in such a way that it requires less construction space and that it works in circumferential direction between the threaded spindle and the spindle nut.

### SUMMARY

In one embodiment, a threaded drive shaft is provided. The threaded drive shaft comprises a threaded spindle and a spindle nut. In the simplest case, the threaded drive shaft refers to a simple moving drive thread. The threads of the threaded spindle and of the spindle nut feature a respective partial circle, which is determined according to the usual definition for screws. If the threaded drive shaft refers to a ball screw drive shaft, then rolling elements, e.g. balls, roll between the respective thread-like tracks that are formed by the threaded spindle on the one side and by the spindle nut on the other side. The partial circle of the threaded drive shaft is described through the centers of the rolling elements in this case. The same applies for rolling screw drive shafts with other types of rolling element, such as e.g. rollers.

A spindle disk may be connected to the threaded spindle in a rotationally fixed manner, but not necessarily in a rigid manner, and a limit stop is formed between the spindle disk and the spindle nut, which works in circumferential direction, wherein the limit stop surfaces are arranged radially completely outside of the partial circle of the spindle nut. On the radial inner side of the core diameter of the threaded spindle, suitable contact surfaces are arranged between the threaded spindle and the spindle disk for the transmitting of torque, which have a different angle from zero and from 90° towards a regular plane in relation to the center axis of the threaded spindle.

In an embodiment, the arrangement of the stop surfaces as well as of the partial circle of the spindle nut completely on the radial outer side of the threaded spindle also has the advantage in comparison to a radial arrangement that is further inside of the stop surfaces, that lower forces have to be absorbed in order to transmit a certain torque. At the same time, it is possible to realize a particularly compact design in axial direction of the threaded spindle by arranging the stop surfaces on the radial outer side of the maximum inner diameter of the spindle nut.

In an embodiment, the contact surfaces that are arranged on the radial inner side of the core diameter of the threaded spindle, on the one hand of the threaded spindle itself and on the other hand of the spindle disk, which serves as supporting disk, are preferably designed at least partially as conical surfaces. The conical shape is hereby preferably designed in such a way that a cone-shaped area, from the viewpoint of one front face of the threaded spindle, in terms of a ring-shaped groove is formed into the threaded spindle. In other words: At least the partial conical contact surface of the threaded spindle represents a concave structure on one surface of the threaded spindle.

In an embodiment, an equally partial conical structure of the threaded spindle interacts with the at least partially conical depression on a surface of the threaded spindle. This structure refers to an elevated, convex structure. Starting from the planar base form of the spindle disk, its conical structure, which represents a contact surface that is intended for the interaction with the threaded spindle, preferably protrudes towards the same side out of the disk which is outlined by the spindle disk as the stop surface of the spindle disk. In this way, functional areas of the spindle nut as well as of the spindle disk are arranged radially within the core diameter, as well as radially outside of the shoulder diameter of the threaded spindle.

In an embodiment, a regular plane exists at least in relation to the center axis of the threaded spindle and thus to the entire threaded drive shaft. This regular plane intersects both with the stop surfaces of the spindle nut and/or of the spindle disk, as well as with the contact surfaces of the threaded spindle and of the spindle disk. This mentioned plane further intersects with a respective section of the threads of the spindle nut as well as of the threaded spindle. In case of a design in form of a ball screw drive shaft, this embodiment at least includes a possible configuration of the threaded drive shaft, in which the mentioned plane also intersects with a roller element, i.e. a ball that is moving between the threaded spindle and the spindle nut.

In an embodiment, the contact surfaces between the threaded spindle and the spindle disk are designed for an interlocking transfer of torque. This can be achieved by, for example, means of non-circular, elliptical cross sections of the contact surfaces or by means of a star- or polygon-shaped design of the contact surfaces.

In an embodiment, at least sections of the contact surfaces of the threaded spindle as well as of the spindle nut preferably form angles with the center axis of the threaded spindle ranging between a minimum of 30° and a maximum of 60°.

Independent of the cross sectional geometry of the contact surfaces, and also in the case that contact surfaces engage into each other in a type of gear tooth system, in an embodiment the contact surfaces are spatially designed in such a way in accordance with an advantageous further development, that wobbling movements between the spindle disk and the spindle nut are permitted. Particularly an adapting to any deflection of components of the threaded drive shaft under high mechanical load is possible by means of such wobbling movements. It may be enough to allow slight tilting, e.g. angular positions up to a maximum of 0.5° of the spindle disk in relation to the threaded spindle.

The spindle disk can be produced very efficiently by means of forming procedures. It is particularly possible to form the stop surface of the spindle disk by means of bending a section of an unfinished art that is first of all planar. In a preceding step, the contact surface of the spindle disk that is intended for the direct contact with the threaded spindle, can be produced by means of extrusion or other non-cutting procedures, for example.

Metal-cutting procedures or combined metal-cutting and forming procedures are also possible for the production of the spindle disk. Powder metallurgy procedures are also suitable for the production of the spindle disk.

If the threaded drive shaft is designed as a ball screw drive shaft, the rolling elements (e.g., balls of the threaded drive shaft) can be fed back in various design forms within the spindle nut. Especially for applications with a short lift, a version of the threaded drive shaft without roller element feedback can also be considered. Optionally, the balls of the threaded drive shaft are lead into a ball cage.

The threaded drive shaft can be used in a brake actuator of a motor vehicle, particularly in a parking brake, in one embodiment.

### BRIEF DESCRIPTION OF THE DRAWINGS

FIG. 1 is a perspective view of a threaded drive shaft in a first operating state, according to one embodiment.

FIG. 2 is a cross-sectional view of the arrangement according to FIG. 1.

FIG. 3 is a perspective view of the threaded drive shaft according to FIG. 1 in a second operating state according to one embodiment.

FIG. 4 is a front end view of the arrangement according to FIG. 1.

FIG. 5 is a cross-sectional view of another embodiment of a threaded drive shaft.

### DETAILED DESCRIPTION

The following explanations refer to both embodiments, unless it is mentioned otherwise. Corresponding parts, or those that basically function in the same way, are identified with the same reference signs in all figures.

A threaded drive shaft, that is identified with the reference sign 1, namely a ball screw drive shaft, can be used in a parking brake of a motor vehicle, for example. With regard to the principal function of the threaded drive shaft 1 as control gears of an electrically operated parking brake, it is referred to the prior art that was quoted in the outset.

The threaded drive shaft 1 comprises a threaded spindle 2 and a spindle nut 3, which is intended to convert a rotation into a linear motion. The threaded spindle 2 in the embodiments refers to a rotating component of threaded drive shaft 1, while spindle nut 3 on threaded spindle 2 is moveable and at the same time secured against co-rotation. In this fashion, the threaded spindle 2 can rotate relative to the spindle nut.

Balls 4 roll between threaded spindle 2 and spindle nut 3 as rolling elements. A ball feedback within spindle nut 2 is not depicted. Spindle nut 3 describes the form of a sleeve with two front faces, whereby one of these front faces has an upstream spindle disk 5, which is coupled to the threaded spindle 2 so that it cannot twist relative to the spindle 2. In the depicted embodiment, the outer diameter of spindle nut 3 corresponds to the outer diameter of spindle disk 5.

On the outer circumference of spindle nut 3, on its front face, which is adjacent to spindle disk 5, a thread is described to some extent, which ends in a limit stop surface 6. A limit stop surface 7 of spindle disk 5 interacts with the limit stop surface 6 of spindle nut 3, so that a limit stop is provided in circumferential direction between spindle nut 3 and the threaded spindle 2. This limit stop surface 7 is located on a limit stop projection 8 of spindle disk 5.

Spindle disk 5 can refer to a metal piece which was produced by means of a forming procedure, whereby the limit stop projection 8 is produced by means of bending a section of the unfinished part.

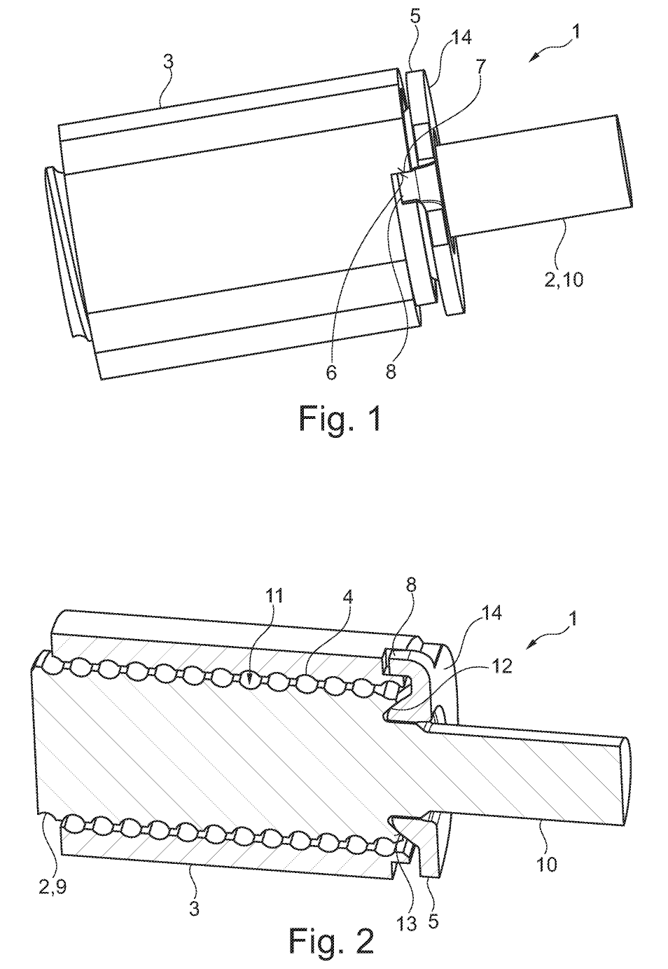

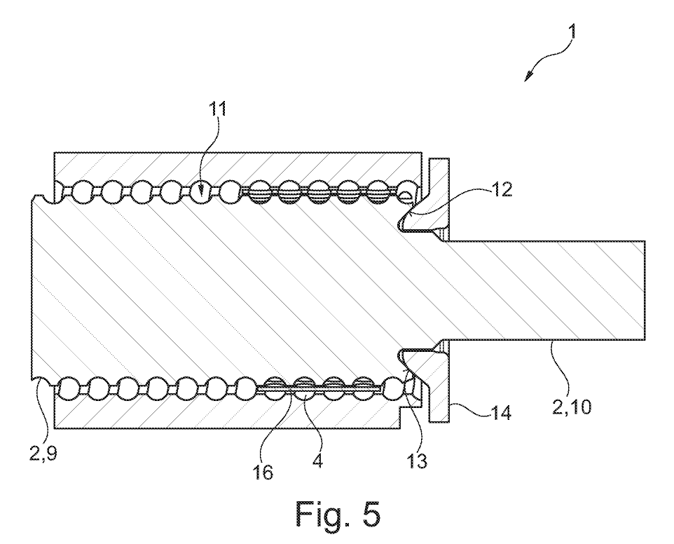

In the arrangement according to FIG. 1, the limit stop surfaces 7, 8 contact each other when the threaded drive shaft 1 is in a first operational state. The same applies to the arrangement according to FIG. 5 wherein the limit stop surfaces 7, 8 are not visible in this case. In both cases, an axial contact of spindle nut 3 with the threaded spindle 2 is prevented by means of the limit stop surfaces 7, 8, which could lead to a tensioning within the threaded drive shaft 1.

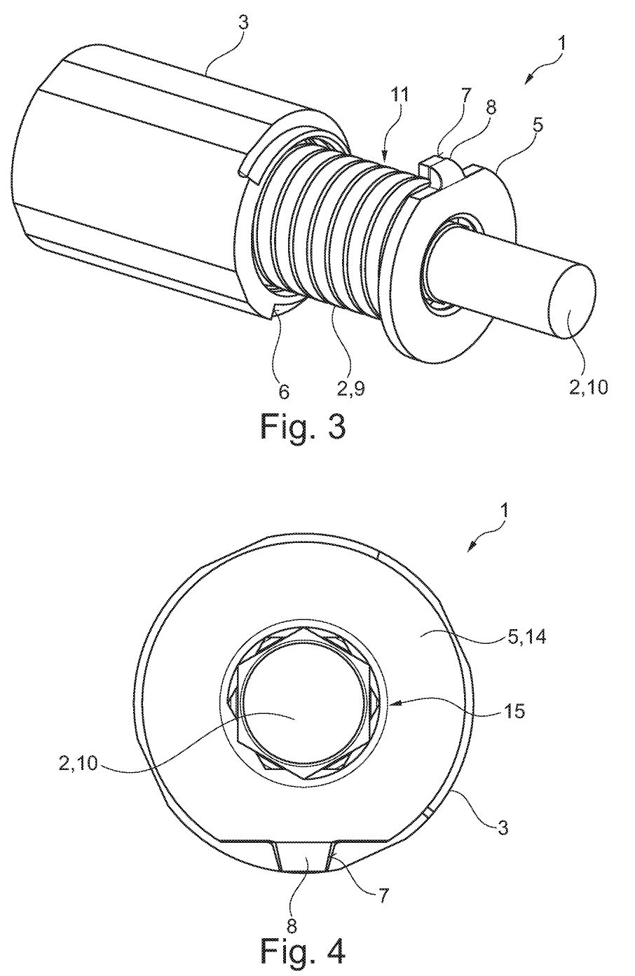

As it can be particularly derived from the FIGS. 2 and 5 that spindle nut 2 features two different sections 9, 10. Section 10 has a smaller diameter than section 9. A thread 11 for the rolling elements 4 is formed on its circumferential surface of section 9 of the spindle nut 2. Section 10 with a comparatively small diameter is adjacent to section 9 in form of a pin, and it does not comprise a thread.

The minimum diameter of section 9 of the threaded spindle 2 that is comprising thread 11 is referred to as core diameter of section 9 according to the common definition for screws. In contrast, the term “shoulder diameter” refers to the maximum diameter of section 9. Section 10, i.e. the pin of the threaded spindle 2, features a uniform diameter, which corresponds to more than 50% of the shoulder diameter.

Spindle disk 5 is held at the transition between the sections 9,10 on the threaded spindle 2 in such a way that it is secured against turning. For this purpose, the threaded spindle 2 has a conical contact surface 12 which is resting against an equally conical contact surface 13 of spindle disk 5. Contact surface 13 is formed by a ring-shaped thickening with a triangular cross section at the inner edge of the spindle disk 5. Starting from a planar front face 14 of spindle disk 5, the conical contact surface is also directed in axial direction towards spindle nut 3, just like the limit stop projection 8. An imagined plane that is aligned normally to the rotating axis of the threaded drive shaft 1, intersects the conical contact surface 13 of spindle disk 5 as well as the stop surface 7 on spindle disk 5. This imagined plane furthermore intersects a respective section of the path for the balls 4 along the inner circumference of spindle nut 3 as well as on the outer circumference of the threaded spindle 2.

The contact surfaces 12, 13 are arranged radially within the core diameter of section 9 of the threaded spindle 2 and are set at an angle of 45° relative to the center axis of the threaded spindle 2 in the embodiments. In the front view shown in FIG. 4, contact surfaces 12, 13 describe a gear toothing that is referred to in total with reference sign 15, which enables an interlocking torque transfer between spindle disk 5 and the threaded spindle 2.

The contact surface 12 hereby describes a hexagonal contour and the contact surface 13 a bi-hexagonal contour. In comparison with two hexagonal contours that are to be coupled together, the threaded spindle 2 and the spindle disk 5 can be coupled with each other in a wide variety of angle configurations in this way. This has the particular advantage that the thread 11, which can be produced e.g. by means of roller burnishing, can be produced at the circumference of the threaded spindle 2 regardless of the angle of the contact surface 12 which describes a hexagon as a whole.

By means of a slightly convex design of the contact surfaces 12,13, it is possible that spindle disk 5 can be slightly tilted towards the threaded spindle 2, without compromising the interlocking torque transfer. This wobbling storage of spindle disc 5 on the threaded spindle 2 is advantageous in all operating modes of the threaded drive shaft 1, especially when spindle nut 3 is at its maximum distance from the spindle disk 5, as depicted in FIG. 3. A limit stop, which prevents a further distancing of spindle nut 3 from spindle disk 5 is not shown in the figures and can be achieved among other things by means of components of a configuration of the environment that is not depicted.

The embodiment according to FIG. 5 differs from the embodiment according to FIGS. 1 to 4 in that the rolling elements 4, namely balls, are fed into a ball cage 16. This guide of the balls 4 does not have any influence on the design and function of the spindle disk 5.

### LIST OF REFERENCE NUMERALS

1 Threaded drive shaft, ball screw drive shaft
2 Threaded spindle
3 Spindle nut
4 Roller element, ball
5 Spindle disk
6 Limit stop surface at the spindle nut
7 Limit stop surface at the spindle disk
8 Limit stop projection
9 Section of the threaded spindle with thread
10 Pin, section of the threaded spindle without thread
11 Thread
12 Contact surface of the threaded spindle
13 Contact surface of the spindle disk
14 Front face
15 Gear toothing
16 Ball cage

What is claimed is:

1. A threaded drive shaft, comprising:
a threaded spindle;
a spindle nut about the threaded spindle to enable rotation of the threaded spindle within the spindle nut; and
a spindle disk connected about the threaded spindle in a rotationally fixed manner, wherein a limit stop is formed between the spindle disk and the spindle nut that works in circumferential direction, the limit stop having limit stop surfaces arranged radially completely outside of a partial circle of the spindle nut, and wherein contact surfaces are provided on a radial inner side of a core diameter of the threaded spindle between the threaded spindle and the spindle disk for torque transfer, wherein the contact surfaces are oriented at different angles from zero and from 90 degrees relative to a plane normal to a center axis of the threaded spindle.

2. The threaded drive shaft according to claim 1, wherein the contact surfaces between the threaded spindle and the spindle disk are at least partially shaped in a conically manner.

3. The threaded drive shaft according to claim 1, wherein the contact surfaces between the threaded spindle and the spindle disk are formed for the torque transfer.

4. The threaded drive shaft according to claim 3, wherein the contact surfaces between the threaded spindle and the spindle disk engage into each other in a type of gear tooth system.

5. The threaded drive shaft according to claim 1, wherein the spindle disk is mounted on the threaded spindle in a way that it can wobble relative to the threaded spindle.

6. The threaded drive shaft according to claim 1, wherein the contact surfaces between the threaded spindle and the spindle disk form angles with the center axis ranging between a minimum of 30° and a maximum of 60°.

7. The threaded drive shaft according to claim 1, wherein the limit stop surfaces of the threads of the spindle nut and of the threaded spindle, as well as the contact surfaces between the threaded spindle and of the spindle disk, are intersected by a common plane regular in relation to the center axis of the threaded spindle.

8. The threaded drive shaft according to claim 1, wherein the spindle disk is arranged axially between (i) a section of the threaded spindle that has at least one thread and (ii) a pin of the threaded spindle, wherein the diameter of the pin is at least 50 percent of an outer diameter of the section of the threaded spindle.

9. The threaded drive shaft according to claim 1, wherein the limit stop surface of the spindle disk is an integrally formed extension of the spindle disk.

10. The threaded drive shaft according to claim 1, further comprising a ball cage with balls that roll between the threaded spindle and the spindle nut.

11. A threaded drive shaft comprising:
a threaded spindle having a first section with a first outer diameter and a second section with a second outer diameter less than the first outer diameter;
a spindle nut about the first section enabling rotation of the threaded spindle within the spindle nut; and
a spindle disk connected about the second section in a rotationally fixed manner, the spindle disk having a tapered surface contacting a tapered surface of the threaded spindle to inhibit rotation of the spindle disk relative to the threaded spindle, the spindle disk further having a flange extending from an outer surface thereof, the flange defining a first limit stop surface configured to contact a second limit stop surface formed on the spindle nut to limit rotation between the threaded spindle and the spindle nut.

12. The threaded drive shaft of claim 11, wherein the tapered surfaces of the threaded spindle and of the spindle disk are oriented at different angles relative to a center axis of the threaded spindle.

13. The threaded drive shaft of claim 11, wherein the flange extends radially outward from the spindle disk and is bent to extend axially relative to the spindle disk.

14. The threaded drive shaft of claim 11, wherein the threaded drive shaft is configured to operate in a first mode in which the threaded spindle has been rotated relative to the spindle nut in one direction such that the spindle disk is axially spaced from the spindle nut, and a second mode in which the threaded spindle has been rotated relative to the spindle nut in another direction such that the flange contacts the second limit stop of the spindle nut.

15. The threaded drive shaft of claim 11, wherein the spindle disk has a partial circular profile with a planar surface, and the flange extends from the planar surface.

16. A threaded drive shaft comprising:
a spindle and a nut coupled to one another via a threaded connection; and
a spindle disk having
an inner surface defining a contact surface tapered relative to a central axis of the threaded drive shaft and contacting a corresponding contact surface of the spindle tapered relative to the central axis, and
an outer surface defining a limit stop surface selectively contacting a corresponding limit stop surface of the nut to selectively inhibit further rotation of the spindle disk relative to the nut.

17. The threaded drive shaft of claim 16, wherein the spindle disk includes a flange extending from a planar surface, the flange defining the limit stop surface of the spindle disk.

18. The threaded drive shaft of claim 16, wherein the contact surface of the inner surface and the contact surface of the spindle are oriented at different angles from zero and from 90 degrees relative to a plane normal to the central axis.

19. The threaded drive shaft of claim 16, wherein the spindle disk is connected to the spindle in a non-rotatable fashion.

20. The threaded drive shaft of claim 16, further comprising balls in the threaded connection.
